(19) United States
(12) Patent Application Publication
(10) Pub. No.: US 2010/0208029 A1
(43) Pub. Date: Aug. 19, 2010

(54) MOBILE IMMERSIVE DISPLAY SYSTEM

(75) Inventors: Stefan Marti, San Francisco, CA (US); Francisco Imai, Mountain View, CA (US); Seung Wook Kim, Santa Clara, CA (US)

Correspondence Address: Beyer Law Group LLP/ SISA, P.O. Box 1687, Cupertino, CA, 95015-1687, US

(73) Assignee: SAMSUNG ELECTRONICS CO., LTD, Suwon City (KR)

(21) Appl. No.: 12/370,738

(22) Filed: Feb. 13, 2009

(51) Int. Cl. H04N 7/14; G06F 3/041

(52) U.S. Cl. 348/14.02; 348/14.07; 345/173; 348/E07.085

(57) ABSTRACT

A mobile content delivery and display system enables a user to use a communication device, such as a cell phone or smart handset device, to view data, images, and video, make phone calls, and perform other functions, in an immersive environment while being mobile. The system, also referred to as a platform, includes a display component which may have one of numerous configurations, each providing extended field-of-views (FOVs). Display component shapes may include hemispherical, ellipsoidal, tubular, conical, pyramidal, or square/rectangular. The display component may have one or more vertical and/or horizontal cuts, each having various degrees of inclination, thereby providing the user with partial physical enclosure creating extended horizontal and/or vertical FOVs. The platform may also have one or more projectors for displaying data (e.g., text, images, or video) on the display component. Other sensors in the system may include 2-D and 3-D cameras, location sensors, speakers, microphones, communication devices, and interfaces. The platform may be worn or attached to the user as an accessory facilitating user mobility.

### BACKGROUND OF THE INVENTION

1. Field of the Invention

The present invention relates generally to mobile communication systems and user interfaces for interacting with voice and video data. More specifically, the invention relates to systems for interacting with data in a mobile, immersive environment.

2. Description of the Related Art

Presently, mobile devices do not provide users who are seeking interaction with three-dimensional content on their mobile devices with a natural, intuitive, and immersive experience. Typically, mobile device displays, such as displays on cell phones, are flat and only allow for a limited field of view (FOV). This is a consequence of the mobile device having a display size that is generally limited by the size of the device. For example, the size of a non-projection or self-emitting display (such as an LCD display) cannot be larger than the mobile device that contains the display. They are small display spaces. Therefore, existing solutions for mobile displays (which are generally light-emitting displays) limit the immersive experience for the user.

Furthermore, it is presently difficult to use mobile devices to navigate through virtual worlds and 3-D content using a first-person view which is one aspect of creating an immersive experience. In addition, mobile devices do not provide an acceptable level of user awareness with respect to virtual surroundings, another important aspect of creating an immersive experience. Some conventional user interface methods require the use of wearable “heads-up” displays or goggles which limit the weight and size of the display and are socially awkward. They also fail to provide the personal privacy many users may desire.

### SUMMARY OF THE INVENTION

In one embodiment, a content delivery system is disclosed. This system may be characterized as a content display and delivery platform comprised of separate components, sensors, interfaces, and processing and communication devices. The system is mobile and may be attached or worn (as an accessory or as clothing) by the user, thereby enabling the user to utilize the platform, for example, while walking. The content delivery system may include a display component that provides an extended field-of-view (FOV) for a user and has an inner display surface. The extended FOV provides an extended horizontal FOV, extended vertical FOV, or a combination of both. The system may also include at least one sensor, such as a location sensor, a camera, or other type of sensor. The system may also include at least one projector, such as a mini-projector, for displaying images on the inner display surface of the display component. Another element of the content delivery system may include an interface that enables communication between a processing device, such as a cell phone, smart handset device, an MP3 player, a notebook computer, or other computing device and the projectors, sensors, and other components in the system. In various embodiments, the display component may have one of various shapes, including hemispherical, conical, tubular, ellipsoidal, pyramidal (triangular), or combinations thereof.

Another embodiment is a method of mobile group communication wherein at least one participant in the communication session uses a content delivery platform. In one embodiment the mobile group communication is videoconferencing, where the user using the delivery platform may be able to see images of the one or more other callers on the display component of the platform while the user mobile. The platform, having a communication device, such as a cell phone, enables a user to participate in a communication session with one or more other callers. The cell phone interfaces with other components and devices in the platform via a platform interface and while conducting the call, may also receive a video stream of images of one or more of the other callers. The video stream or data is transmitted, for example via Bluetooth or Wi-Fi, to one or more projectors in the delivery platform or to other components, such as the display component itself if, for example, the display is a self-emitting display. The one or more projectors display the images from the video stream onto the inner surface of the display component where the user is able to see the images, which may typically be of the other callers. In this manner a mobile videoconferencing application using the content delivery platform may be implemented.

Another embodiment is a method of utilizing the mobile content delivery system for displaying geo-coded data related to an object or location. This application may be characterized in one embodiment as a mobile augmented reality application. Information or data on a particular object (e.g., a structure, building, landmark, tourist attraction, etc.) or location is obtained from sources, such Web sites or fixed data repositories (e.g., hard drives on devices contained in the system) and is displayed on the display component of the content delivery system thereby allowing a user to view the actual object or location (the “reality” aspect) while viewing information about the object or location on a display component of the content delivery system (the “augmented” aspect of the application). In one embodiment, the system obtains a signal or data from a transmitter on an object (a landmark/tourist site) or uses a location sensor in the system, such as a GPS component, to obtain location data. This data may be referred to generally as origin data. In one embodiment, the origin data may be transmitted to the system's communication device, which is IP-enabled, such as an IP-enabled cell phone or any mobile device capable of accessing the Internet. In another embodiment, the device receiving the origin data may not be IP enabled but may have memory that contains geo-coded data on the various objects and locations that the user may be visiting. In the embodiment where the Internet is used, a request for geo-coded information is transmitted via the IP-enabled cell phone. The request may be formulated using the origin data. The geo-coded data is obtained and may be displayed on the display component such that the actual object or location seen by the user is augmented with the geo-coded data.

### BRIEF DESCRIPTION OF THE DRAWINGS

References are made to the accompanying drawings, which form a part of the description and in which are shown, by way of illustration, particular embodiments:

FIGS. 1A to 1L are perspective illustrations of spherical-based display component configurations in accordance with various embodiments;

FIGS. 2A to 2C are perspective illustrations of conical and tubular-based display component configurations in accordance with various embodiments;

FIGS. 3A to 3D are perspective illustrations of triangular and rectangular-based display component configurations in accordance with various embodiments;

FIG. 4 is a side view of a front projection embodiment of the present invention;

FIG. 5 is a side view of a “surround” embodiment of the present invention;

FIG. 6A is a side-view of the mobile platform with a camera attached to the front of a display component in accordance with one embodiment;

FIG. 6B is a side-view of the mobile platform with a camera attached to the rear of a display component in accordance with one embodiment;

FIG. 6C is a side-view of a mobile platform with a rear camera projected on to an outer display surface area in accordance with one embodiment;

FIG. 6D is a side view of a mobile platform with a camera positioned at the top of a display component in accordance with one embodiment;

FIG. 7 is an illustration of a multi-party teleconferencing application of the mobile platform in accordance with one embodiment;

FIG. 8 is a flow diagram of a process for multi-party teleconferencing using the mobile platform in accordance with one embodiment;

FIG. 9 is an illustration of a mobile augmented reality application of the mobile platform in accordance with one embodiment; and

FIG. 10 is a flow diagram of a process for mobile augmented reality using the mobile platform in accordance with one embodiment.

### DETAILED DESCRIPTION OF THE INVENTION

Mobile multimedia content display systems providing an immersive user experience with extended field-of-views when interacting with different types of content and methods of using them are described in the various figures. In the described embodiments, the system, also referred to as a platform, has a display component that is configured to give the user an extended field-of-view (FOV) when viewing content. The platform may also provide surround or stereoscopic sound to the user. The FOV for the user is extended in that it provides the user with horizontal and vertical FOVS that are greater than those that are typically attainable with flat or slightly non-planar display components often found in consumer devices (e.g., cell phone, laptops, handset devices, mobile gaming devices, etc.) when viewed at a normal distance (e.g., not unusually close).

In one embodiment, the platform has a network interface that allows it to communicate with a processor. The processor may be a cell phone or some type of handset device capable of communicating data, accessing the Internet, and the like. It may also be an MP3 player, laptop, notebook, so-called “netbook” computer, or portable gaming device; generally a computing device that is lightweight and portable. In some embodiments a processor may not be necessary. In addition to the display component and network interface, the mobile content display platform may have other components, such as projectors, various types of cameras, location sensors, microphones, speakers and various types of other components.

In one embodiment the user connects the platform to a cell phone, handset device, or other computing device, such as those listed above, via a wired or wireless interface, such as Bluetooth, Wi-Fi, or other standard. The interface enables transmission of voice and data between the cell phone and the platform. It may be noted that the entire platform itself may be characterized as an accessory for a cell phone. In one embodiment, a specific component within the platform that receives the data is a projector, described in greater detail below. The data and images are displayed to the user via a projection surface, referred to as a display component, which has an inner display surface viewable by the user and which provides an extended FOV. The display component may also have an outer display surface. Before describing other components, devices, and sensors of the content delivery platform and various methods in which the platform may be used (e.g., mobile video conferencing), the display component is described.

The display component may have numerous configurations and shapes. Some are curved and others are comprised of multiple planar surfaces. However, all may provide an extended FOV to the user. Some configurations are variations on a basic shape, such as spherical (dome), conical, triangular, ellipsoidal, and so on. In one embodiment, the display component is derived from a basic hemispherical shape and is sufficiently large to provide partial physical enclosure of the user. Through this partial physical enclosure (some may be close to complete but fall short of total enclosure), the display component creates a confined space between the user and the display component, facilitating user gesture detection and providing the user with personal privacy.

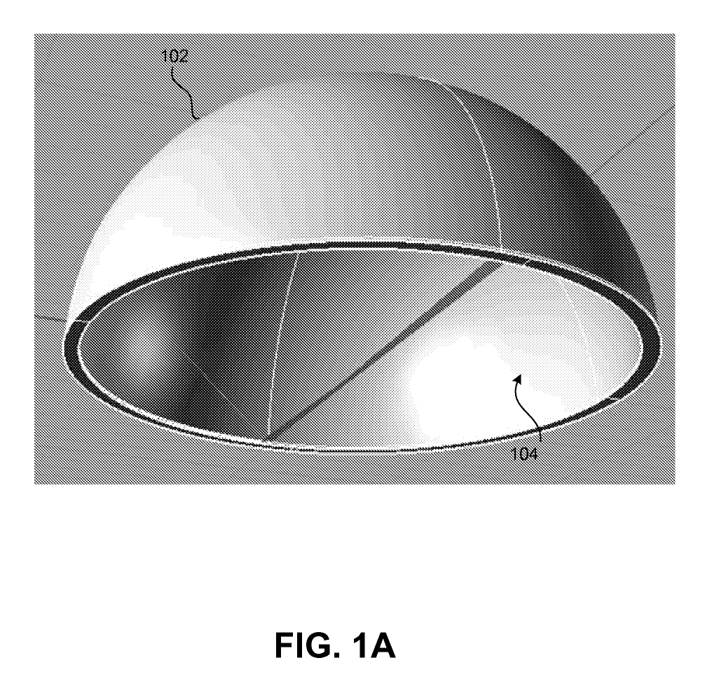

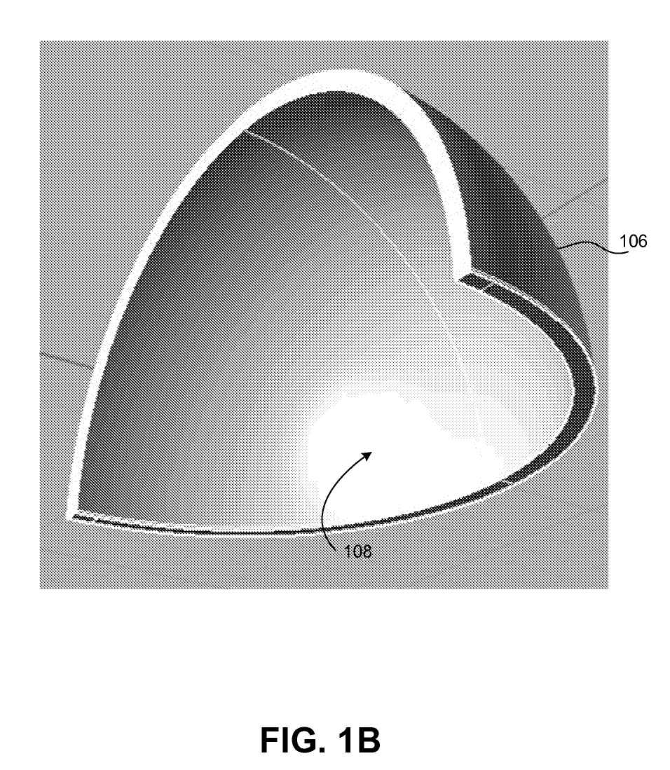

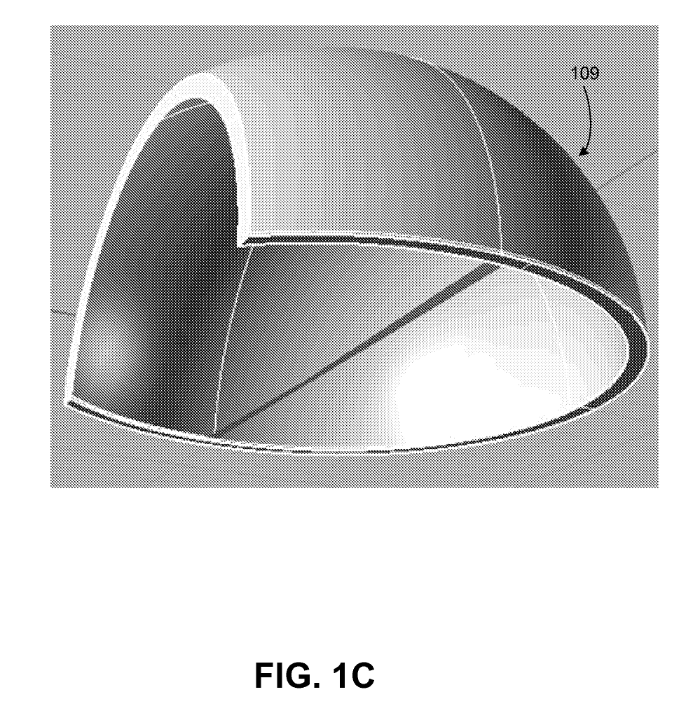

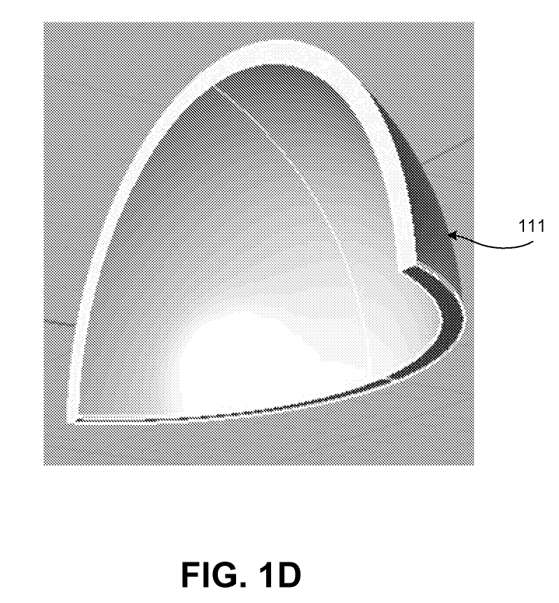

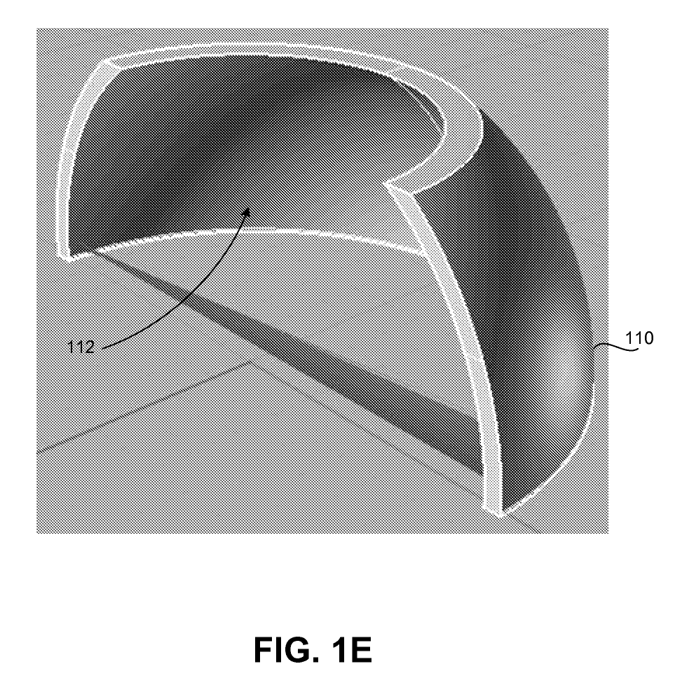

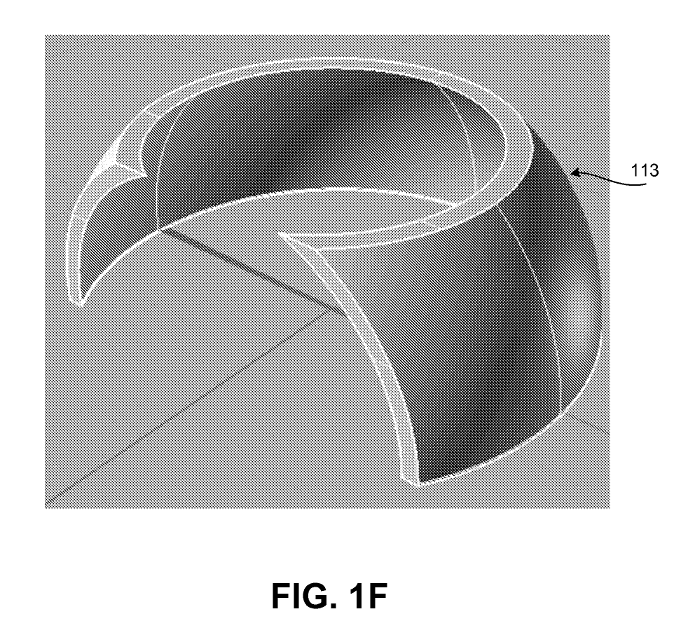

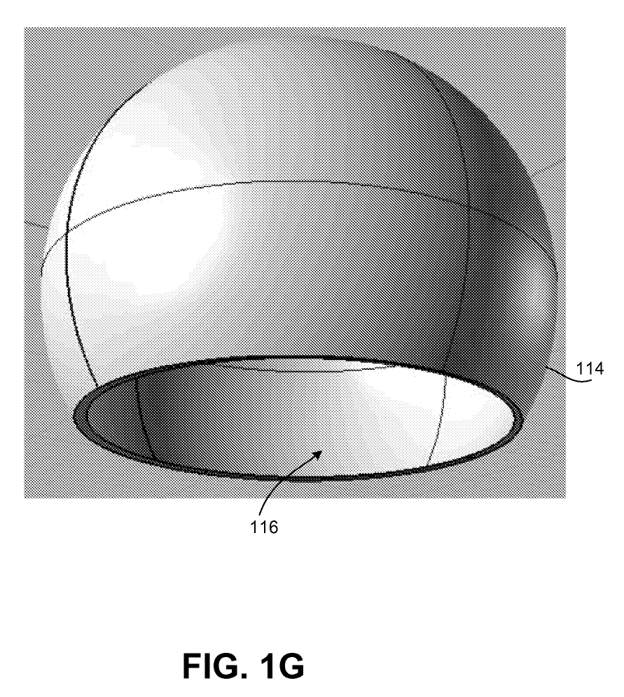

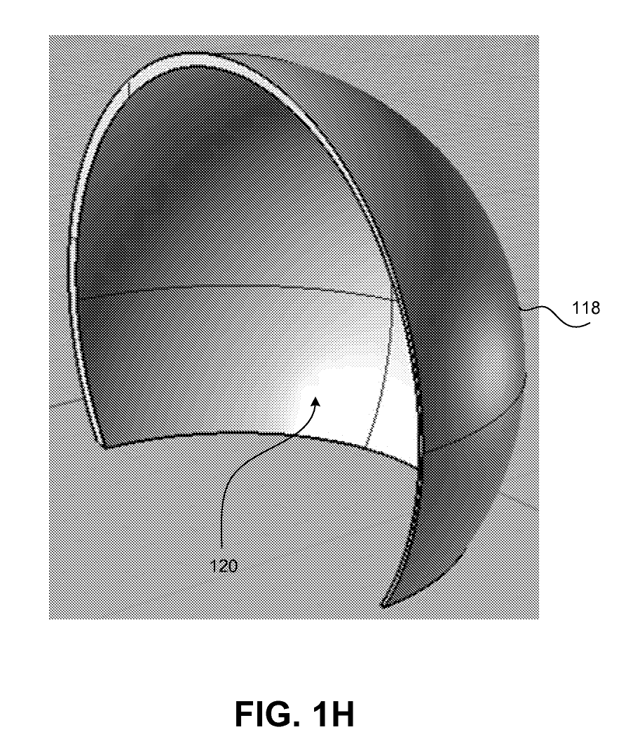

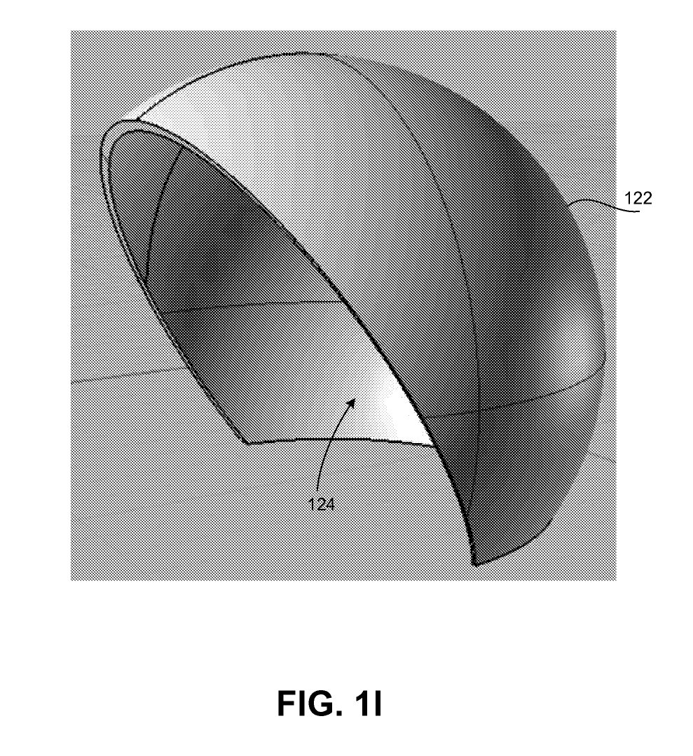

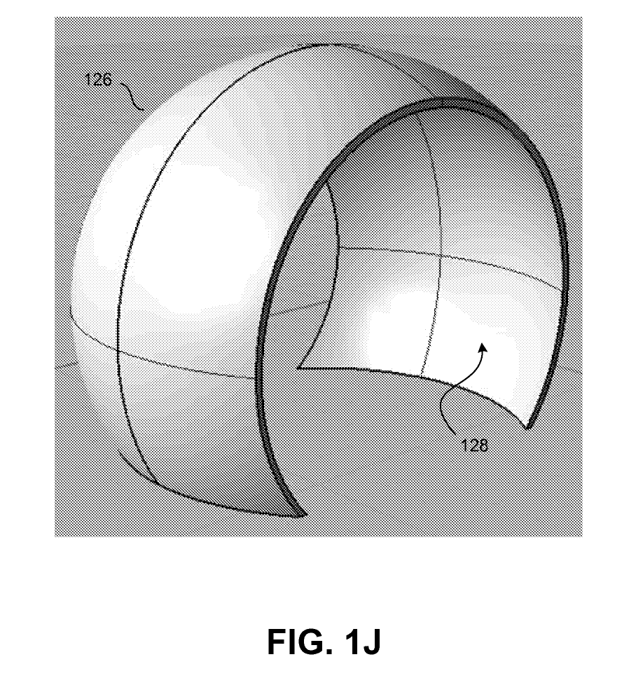

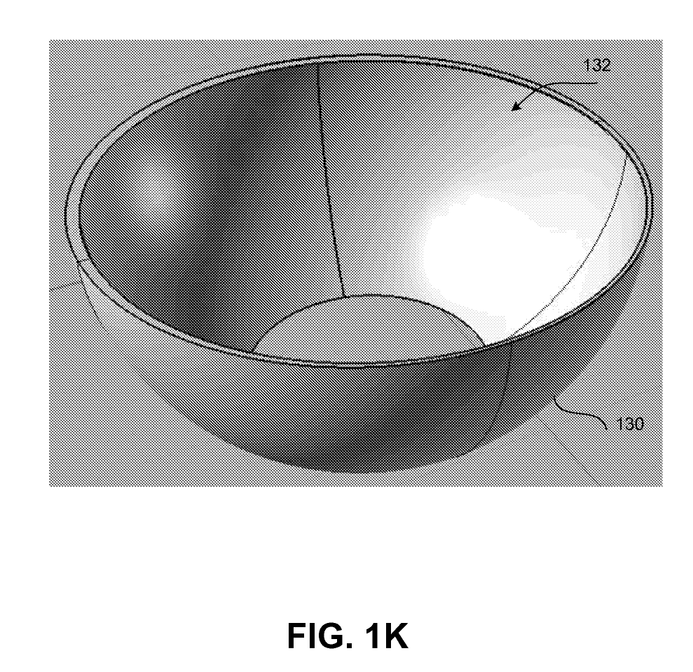

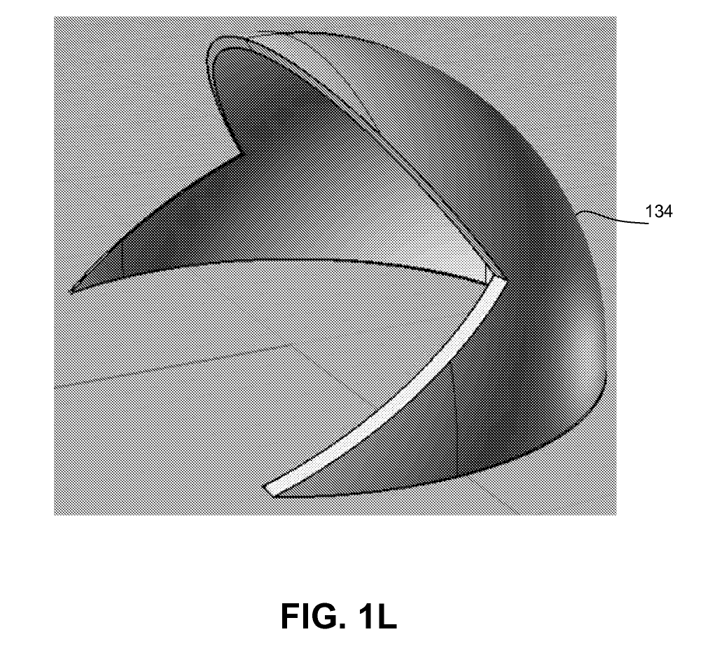

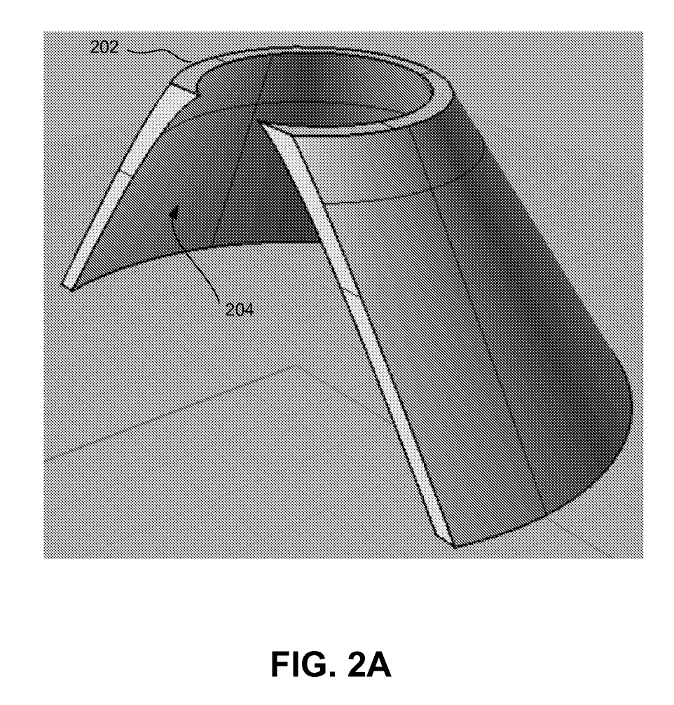

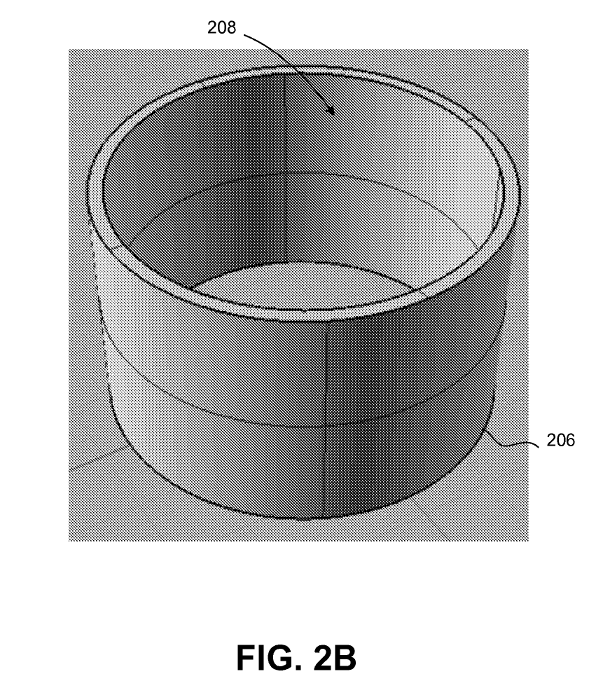

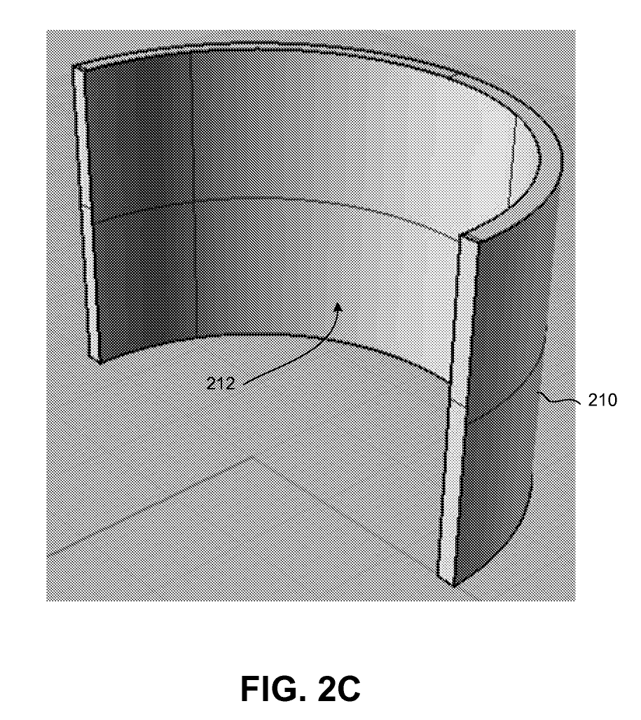

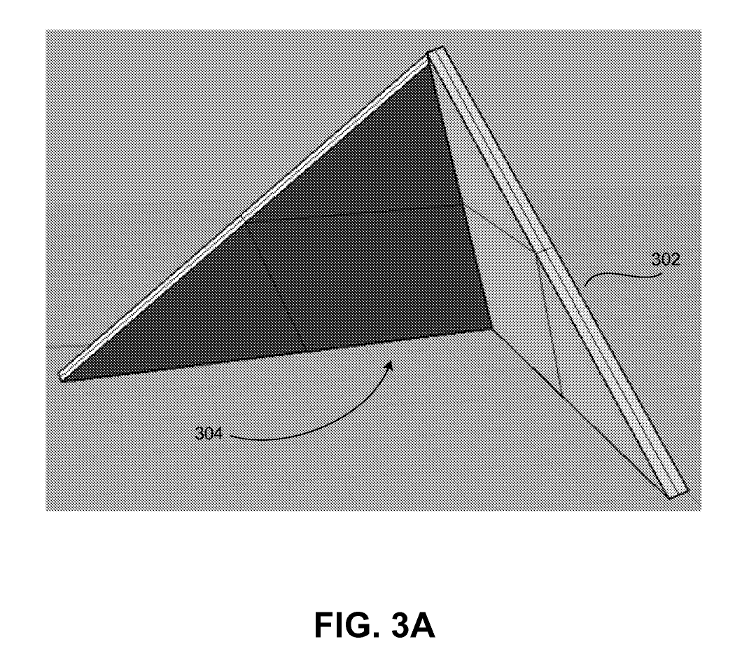

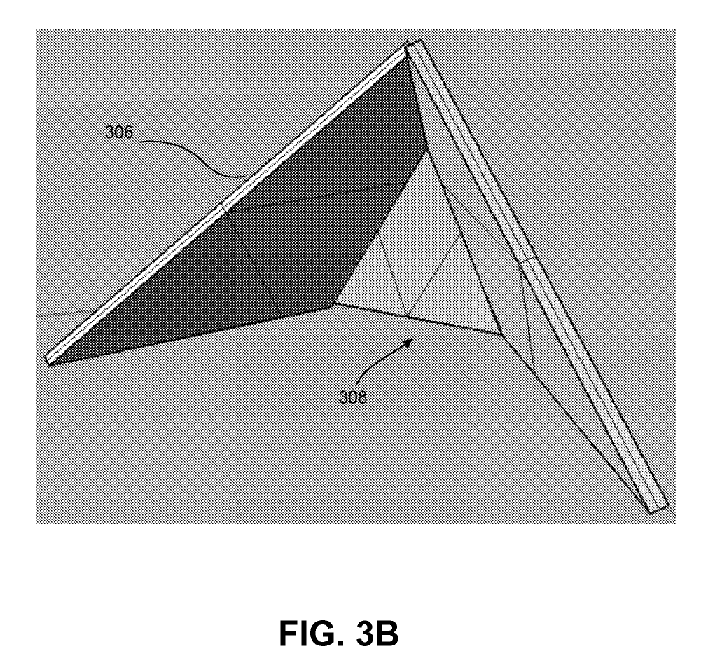

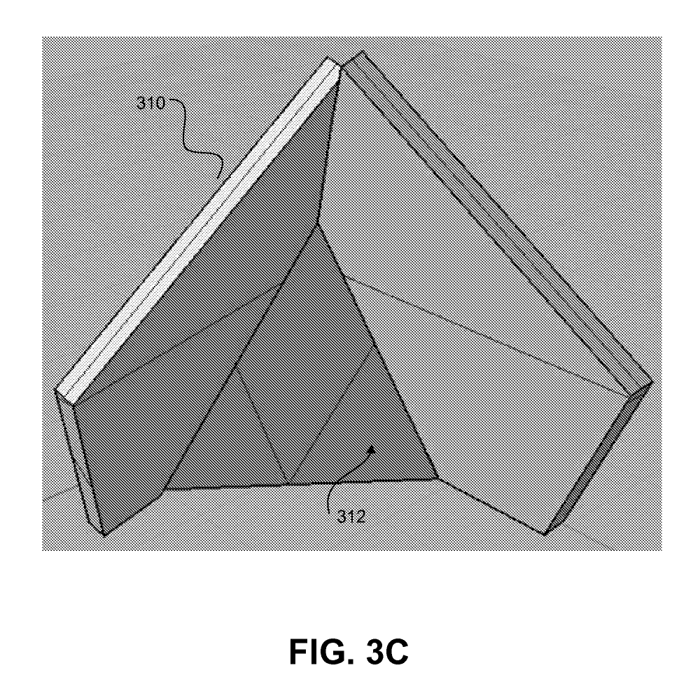

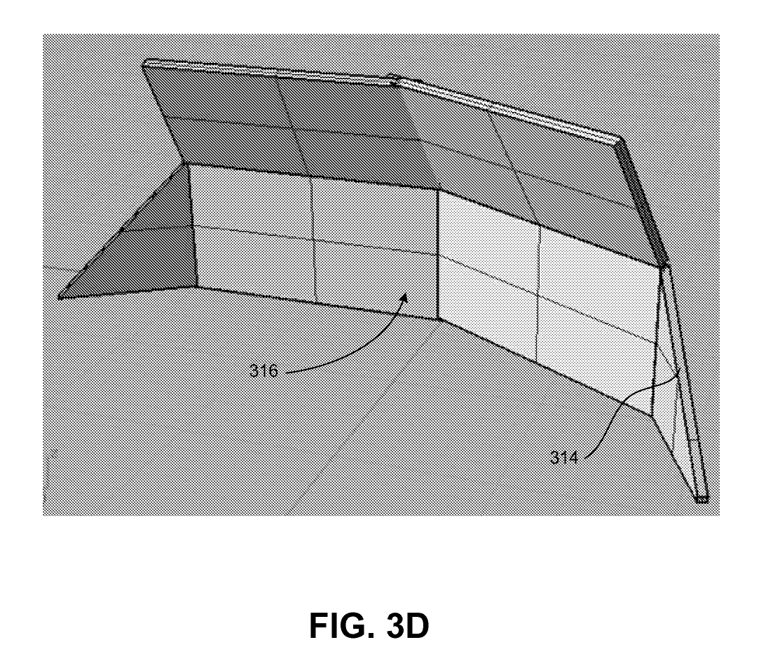

From the basic spherical shape, many different configurations may be derived by cutting away at the sphere at different vertical and horizontal angles, including, for example, cutting away at the top of the sphere so that the top is open or cutting away (horizontally) at the top and one or both sides. These configurations are best shown through the various figures. Examples of spherical-based display component configurations are shown in FIGS. 1A to 1L. Other configurations based on conical, triangular, and tubular shapes are shown in FIGS. 2A to 2C and FIGS. 3A to 3D. Before turning to the figures, it is useful to describe features of the display component in accordance with various embodiments.

The display component may be variably transparent from the inside looking out (i.e., from the perspective of the user) as well as variably transparent from the outside looking in (i.e., from the perspective of a passer-by). In one embodiment, the display component is opaque from the outside looking in and fully or semi-transparent from the inside looking out. In another embodiment, the transparency may vary from the inside looking out at different areas of the display component. For example, content may be displayed on the inside surface of the display component that is semi-transparent; that is, the user can see the content displayed but can also see through the content and through the display component material and see real objects outside the display component. In another embodiment the display component may be a combination of polarized light and a polarized projection surface. The image light may be polarized projector light (i.e., light that is reflected on a specialized polarized screen).

The material of the display component may be a self-emitting or actively emitting display material, such as OLED, LCD or any other known self-emitting material. In such an embodiment, the system may still have a projector for projecting images onto the inner surface of the display component, even though it may not be needed given that the display component is self-emitting. The material may also be fabric, plastic, or other non-self-emitting material. In some embodiments, the display component has the functionality of a curved surface and may be comprised of an actual curved material or be made up of multi-planar surfaces (tiled). In another embodiment, the display component is collapsible or foldable, allowing the user to fold the display component of the mobile multimedia platform and stow it in a bag, briefcase, or backpack (much like a user may do with any other cell phone or media player accessory). In another embodiment the display component may be inflatable, whereby the display surface provided by the display component is truly curved. In other embodiments, the display component may be rigid or non-rigid, which does not necessarily have a bearing on whether the component is collapsible (a component may be rigid and collapsible). The display component may also have touch-sensitive capabilities. For example, the user may be able to touch all or certain portions of the inside surface of the display component to activate functions, manipulate data, make adjustments to the user interface, and so on.

FIG. 1A is a perspective illustration of a hemispherical display component 102 (a “dome” shaped display) derived from cutting a sphere in the middle. Display component 102 has an interior display surface 104 that is seen by the user. Surface 104 provides an extended horizontal FOV for the user, as well as an extended vertical FOV. Component 102 may have none, some, or all of the features and characteristics described above. For example, it may be close to being fully transparent (this feature is not evident from the figure). It is worth noting here that the configuration shown in FIG. 1A and in all the display component figures below show only the display component of the platform. Other features, such the attachment/holding means for the user, the projector(s), camera(s), the variety of sensors and components, and the communication means between the processing source (e.g., cell phone, media player, notebook PC, etc) and the platform, are not shown in these figures, so as not to obstruct the illustration of the numerous example configurations described herein. FIG. 1B is a perspective illustration of a quarter-sphere display component 106 having an inside display surface 108, which provides a maximum horizontal FOV of 180 degrees and maximum vertical FOV of 90 degrees. FIG. 1C is a perspective illustration of a variation of the hemisphere configuration where the extended horizontal FOV of a display component 109 is greater than 180 degrees. FIG. 1D is a perspective illustration of the hemisphere configuration where the extended horizontal FOV of a display component 111 is less than 90 degrees. In both display components 109 and 111 the vertical FOV varies as well.

FIG. 1E is a perspective illustration of a quarter-based display component 110 where the top is cut away horizontally. An interior display surface 112 provides a maximum horizontal FOV of 180 degrees and a vertical FOV of less than 90 degrees. With this configuration of a display component, a user walking outside has an unobstructed view of the sky above. FIG. 1F is a perspective illustration of display component 113 showing a variation of the configuration shown in FIG. 1C where the top is cut away horizontally, also allowing to have an unobstructed view looking up. On the same note, all the display component configurations in FIGS. 1B to 1F allow an unobstructed view of the space to the rear (the display component does not block their view behind them). In contrast to these configurations, FIG. 1G is a perspective illustration of a sphere-based display component 114 that also provides a partial enclosure to the user but has more interior display surface 116 than any of the other configurations. In this configuration, the bottom of the sphere is cut away horizontally to allow the user to place display component 114 essentially over her head. The extended horizontal FOV may be over 270 degrees and the extended vertical FOV is greater than any of the others shown. The user may be able to turn around and face the other side of interior display surface 116.

FIG. 1H is a perspective illustration of a display component 118 having an interior display surface 120 that is a variation of display component 114, cut at a vertical angle. With this configuration, the user has a partial view of what is above and a full view of what is behind. Display surface 120 provides an extended horizontal FOV that is somewhat greater than 180 degrees and an extended vertical FOV that is somewhat greater than 90 degrees. FIG. 1I is a perspective illustration of a display component 122 that is a variation of display component 118 having an interior display surface 124 that provides a greater extended horizontal FOV 124.

FIG. 1J is a perspective illustration of a display component 126 that is spherical-based with two sides cut away vertically and the bottom cut away horizontally, as in FIGS. 1G to 1I. In this configuration, an interior display surface 128 has an extended vertical FOV that is greater than 270 degrees in which a user can turn around. The extended horizontal FOV is less than 180 degrees. Here the user has an unobstructed view of her left and right sides. FIG. 1K is a perspective illustration of a spherical-based display component 130 having an interior display surface 132. Display component 130 is the bottom half of a hemisphere with a horizontal cut away at the bottom of the hemisphere to allow the user to enter (or wear) the display component. Display surface 132 provides the same extended horizontal FOV as the configuration shown in FIG. 1A and an extended vertical FOV that is 180 degrees with a break in the view at the bottom portion of the hemisphere. In this configuration of a display component the user is able to look up and around without any display component obstructing her view, although it is still a partial enclosure of the user. Here the user can look straight and see real objects in front, but only have to look down and around to see multimedia content displayed on display surface 132. FIG. 1L is a perspective illustration of a display component 134 that is a variation of a hemisphere configuration shown in FIGS. 1A and 1B. The extended horizontal and vertical FOVs are evident from the illustration. As with some of the other configurations, the user is able to see behind and has partial views of sides (and can see down).

FIGS. 2A to 2C are perspective illustrations of display components that are based on a conical shape. FIG. 2A is a perspective illustration of a conical display component 202 having a horizontal cut across the top providing an opening above the user and a vertical cut away enabling an extended horizontal FOV of greater than 180 degrees. Variations of display component 202 may include horizontal cuts lower or higher and vertical cuts at different angles. FIG. 2B is a perspective illustration of a tubular display component 206 with openings at the top and bottom which maintain a partial physical enclosure even though a display surface 208 creates a 360 degree display area around the user. FIG. 2C shows a variation of display component 206. A semi-tubular display component 210 has a vertical cut away at 180 degrees with an inner display surface 212 that provides a user with a 180 degree horizontal FOV.

FIGS. 3A to 3D are perspective illustrations of a display component that are based on a triangular (pyramidal) shape. FIG. 3A is a perspective illustration of a basic triangular-shaped display component 302 having an inner display surface area 304 comprised of two planar display tiles providing a 180 degree horizontal FOV FIG. 3B is a perspective illustration of a triangular-based display component 306 having an inner display surface area 308 made up of three planar display tiles. FIG. 3C is another perspective illustration of a triangular-based display component 310 having an inner display surface area 312 also made up of three planar display tiles. FIG. 3D is a perspective illustration of a combination of rectangular and triangular-based display component 314 having a display surface area 316 comprised of six planar display tiles.

Various other shapes and derivations thereof may be used to configure the display component of the mobile multimedia platform. The configurations illustrated above show only some examples that are representative of basic shapes (dome/spherical, triangular, conical, tubular, ellipsoidal, among others); many others that provide an extended FOV either horizontally, vertically, or both, may be used as a display component. More generally, a display component has an overall or general shape, such as one of those listed above. It may also be possible that the display component has an overall shape that is a combination of two or more basic shapes. Other parameters of a display component may be the number of horizontal and vertical “cuts” or cutting plane in the basic shape, the angle or inclination of the cuts, and the position of the cuts. All or some of these parameters may vary to provide a multitude of different display component configurations. With some basic shapes, such as tubular or conical displays, parameters may also be described as the inclination of the inner display surface in relation to a central axis of the tubular or conical structure.

In addition to the display component, the mobile multimedia display platform of the various embodiments may have a number of other components, such as cameras, projectors, location sensors, speakers, and so on. These components and methods of using them in certain applications, such as multi-party videoconferencing and mobile augmented reality, are described by way of example configurations as shown in the figures below. By describing these applications, contexts, arrangements, and functionality of the components may be described as well.

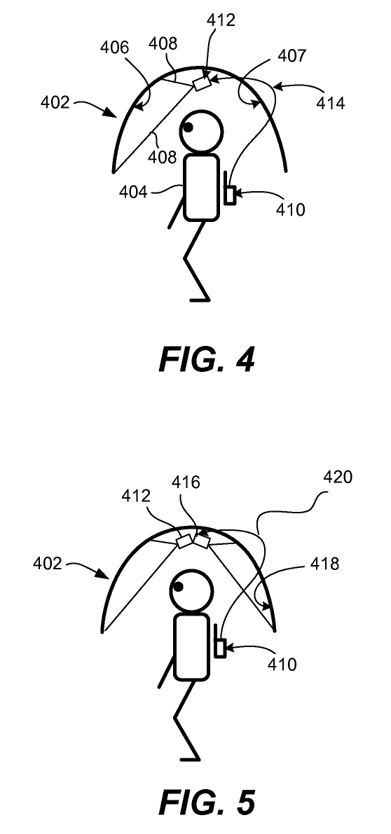

FIG. 4 is an illustration of a side view of what may be described as a front projection embodiment of the present invention. A display component 402 is shown as a hemispherical-shaped (or dome-shaped) display similar to the example shown in FIG. 1A. A user 404 looks at an inner display surface area 406 shown approximately by lines 408 (for reference, the entire inner display surface is 407). The area delimited by lines 408 may be referred to as a stand-by or starting FOV of display component 402; it is the area user 404 sees when looking straight ahead at display component 402 under normal circumstances. User 404 may move her head and see more of inner display surface area 407. Inner display surface 407 is shown more clearly in FIG. 1A as area 104. User 404 has attached a mobile device 410, such as a cell phone or other computing device capable of voice and data communications. User 404 may also hold mobile device 410 instead of attaching it to the waist, clothing, backpack, purse, or other accessory. Mobile device 410 may have wired or wireless communication with other components in the platform, which has a communication interface (not shown in FIG. 4). An example of wireless communication is a video stream 414, described below.

Also shown in the platform illustrated in FIG. 4 is a projector 412. There may be more than one projector (e.g., see FIG. 5). Projector 412 receives data from a data source, typically mobile device 410, which may be a cell phone, MP3 player, or DVD player, and projects images on inner display surface area 406 of display component 402. The data is shown in FIG. 4 as video stream 414 over a wireless connection. In another embodiment, mobile device 410 may have a wired connection to projector 412 via a communication interface of the platform. In a preferred embodiment, projector 412 is mobile, light-weight and small, such as a mini-projector, commercially available from Microvision, 3M, Light Blue Optics, and Neochroma. The front projection configuration shown in FIG. 4 provides a “heads-up” display style where the user can view text messages, graphics, and other types of data on inner display surface area 406.

FIG. 5 is an illustration of a side view of what may be referred to as a “surround” embodiment of the present invention. In this embodiment there are two mini-projectors 412 and 416. Projector 412 displays images on inner display surface area 406 (as shown in FIG. 4) and projector 416 displays images on an inner display surface area 418. In other embodiments, a single projector may project one or more images at a 270 degree angle or greater. Projectors 412 and 416 receive data from mobile device 410. In this embodiment images are projected in front of and behind the user. A video stream 420 is transmitted from mobile device 410 to projectors 412 and 416. Images may also be projected to the right and left sides, depending on the capabilities of the projectors and their positions, thereby increasing the immersiveness of the user interaction. In another embodiment, there may also be a wide-angle projection lens (not shown), also referred to as a surround lens, that adds to the platform's ability to provide an immersive environment for the user.

In other embodiments there may also be more than two projectors positioned at the top of display component 402 or along the lower peripheral edge of component 402. These embodiments provide extended wide angle projection (up to 360 degrees), which is suitable for certain types of applications that may be used even when a user is walking. Of course, the location of projectors and inner display surface portions where they project images will depend largely on the configuration of display component 402. To show one example, projector positioning will be different for the configuration shown in FIG. 1E, where there is no top portion of the hemisphere (or dome). Given the size of mini-projectors that are becoming available, their ability to focus images on small or oddly shaped display surfaces and their wireless capabilities allow them to be placed in a variety of different locations in display component 402 while still providing images or data to the user.

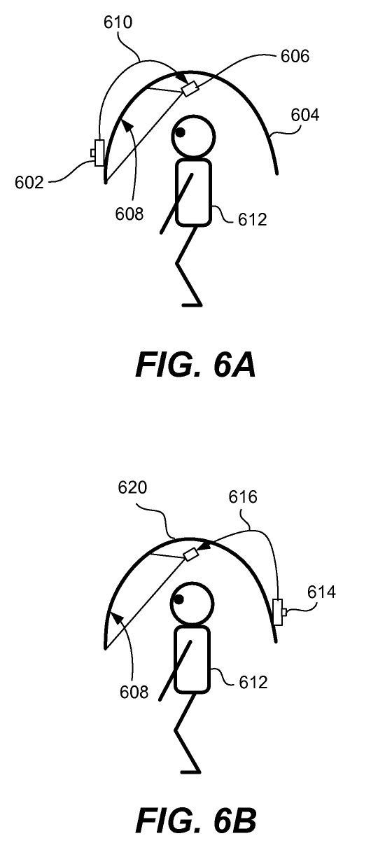

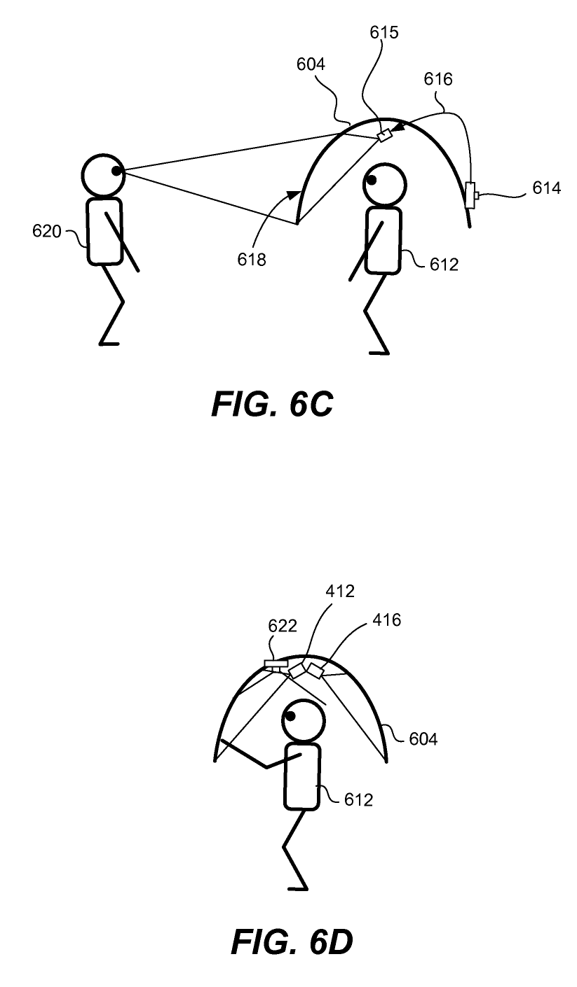

As noted above, the platform may also have one or more cameras, which may be regular 2-D cameras or may be 3-D (depth) cameras. FIGS. 6A to 6D show various camera locations in one example platform. Again, the hemispherical dome shaped display component shown in FIG. 1A is used as one example to illustrate the various embodiments. In FIG. 6A a camera 602 may be attached to the front of a display component 604. Images captured by camera 602 are transmitted via video stream 610 over a wireless or wired connection to a projector 606 and displayed on inner display surface 608. This type of camera arrangement may be useful in cases where display component 604 is opaque or is such that it is difficult for a user 612 to see directly in front of her (thereby making it difficult for the user to walk, for example, on a sidewalk). In this embodiment, and in the ones described below, there may be more than one projector that receives video stream 610 being transmitted from camera 602 (see FIG. 5).

FIG. 6B shows another configuration where a camera 614 is attached to the rear of display component 604. This configuration enables a “rear view” functionality for user 612. In the embodiment of FIG. 6B, images in video stream 616 which are of the area behind user 612 are displayed on inner display surface 608 so that user 612 can see what is behind her and, preferably, can still see what is in front. For example, the display component material may be semi-transparent or be variably transparent. Images may be displayed to the side so that the user can see directly in front.

FIG. 6C shows an embodiment where a video stream 616 of rear view images may be displayed using projector 615 on an outer display surface area 618 where another person 620, such as someone walking by user 612, sees images from video stream 616 on outer surface 618, thus, in a sense, “cloaking” user 612 and display component 604. Cloaking is a technique that allows an object or individual to be partially or wholly invisible to parts of the electromagnetic spectrum. In this embodiment, user 612 may also be able to see video stream 616 on inner display surface 608 as well.

In FIG. 6D a gesture detection sensor 622 is positioned at the top of display component 604 or may be placed at another location depending on the configuration of the display component. Also shown are two projectors 412 and 416 as shown in FIG. 5. In one embodiment sensor 622 is a 3-D camera (depth camera). It may also be a regular 2-D camera that is capable of tracking a user's motions. In the example shown in FIG. 6D, the physical space in which user 612 can perform gestures is well defined, that is, the space between user 612 and display component 604 is typically small (not more than an arm's length away) making the space that needs to be monitored small. The confined space provided by this embodiment enables easier gesture detection since a user's hands and arms need only be tracked within a relatively small spatial area which has no other moving elements, greatly reducing the computations and tracking required in conventional gesture detection. Further details on the use of depth cameras for gesture detection are described in patent application Ser. No. 12/323,789, titled Immersive Display System for Interacting with Three-Dimensional Content, filed on Nov. 26, 2008, incorporated by reference herein in its entirety and for all purposes.

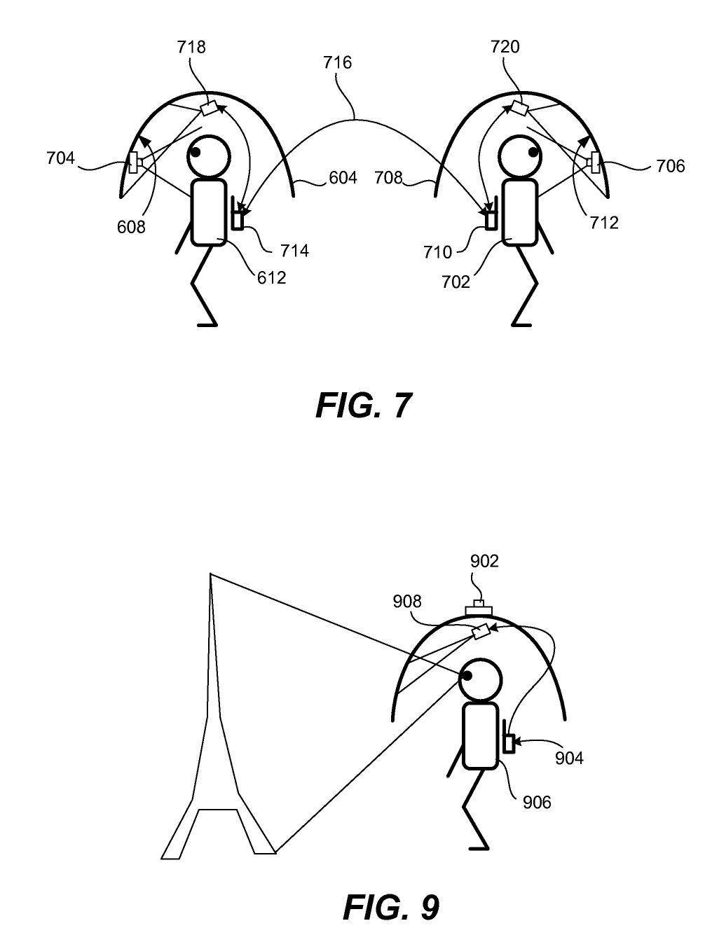

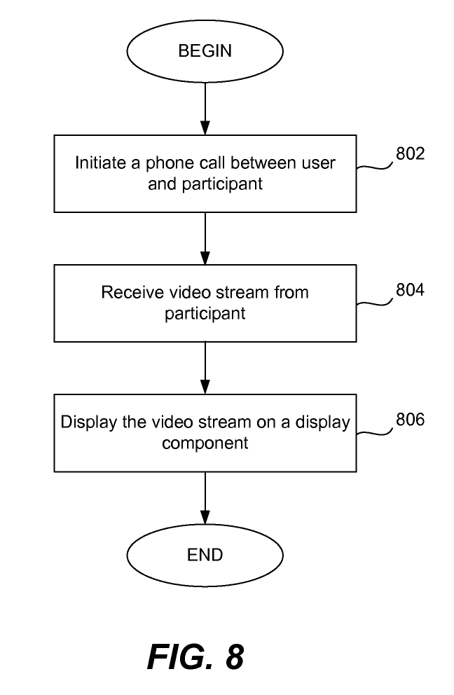

FIG. 7 is an illustration of a multi-party videoconferencing application of the mobile multimedia platform showing another use of cameras and other sensors in the platform. A camera may be placed inside display component 604 so that it is facing user 612. Although the concept of video conferencing is known, in this application at least one of the users (user 612) is mobile (e.g., walking in public) and can see the other participants on display component 604, specifically inner display surface area 608. FIG. 8 is a flow diagram showing a process of implementing a videoconference call using the mobile content display platform in conjunction with FIG. 7. In FIG. 7, user 612 is using a cell phone 714 to make a call to a user 702 equipped with cell phone 710. This is shown at step 802 in FIG. 8 where the user initiates a call with participant, such as user 702. The participant may not be using the platform of the present invention, but rather may only be using a cell phone, wired phone (“land line”) or other communication means (e.g., VoIP) and a camera. User 612 has a camera 704 attached to display component 604 and facing user 612. User 702 has a camera 706 attached to a display component 708 and facing user 702. Images from camera 704 are transmitted over a wireless path 716 via cell phone 714 to cell phone 710. Images of user 702 are transmitted from camera 706 via wireless path 716 to cell phone 714 of user 612. At step 804 of FIG. 8, cell phone 714 receives a video stream originating from a video conference call participant. In addition to the configuration shown in FIG. 7, the video stream may come from a cell phone having a user-facing camera, a computer with a Webcam (using Internet-based communication techniques), or a land line and Webcam. Images of user 702 are sent to projector 718 from cell phone 714 and projected on inner display surface area 608 as shown in step 806 and which stage the process is complete. Likewise, images of user 612 are displayed by projector 720 on an inner display surface area 712 for user 702 to view. Users 612 and 702 are able to speak with each other using speakers and microphones (not shown) which may be components of cell phones 714 and 710 or may be separate components of the mobile content delivery platform. In another embodiment, if there are more than two participants in a conference call, their images may be lined adjacently or side-by-side in a panoramic style so that each participant (using the mobile platform of the present invention) may be able to see each caller, for example, on sides of the display component, while keeping the center (area directly in from of the user) clear so that the user can see.

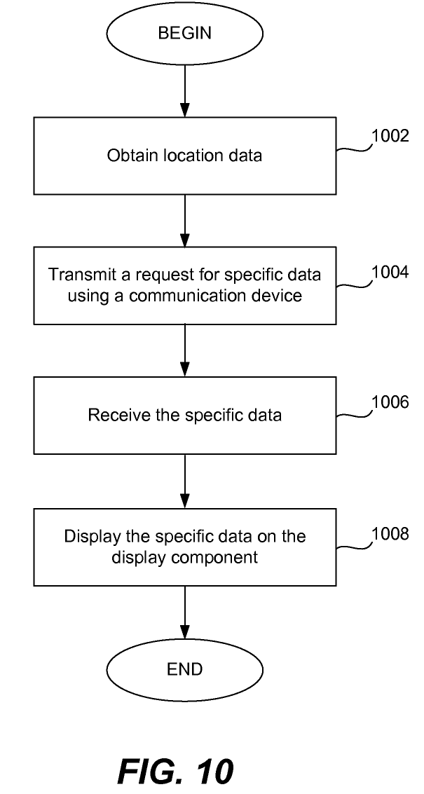

FIG. 9 is an illustration showing what may be referred to as a mobile augmented reality application of the content delivery system or platform in accordance with one embodiment. Many components of the platform are the same as those described above. However, in the augmented reality application described herein, in one embodiment, a location sensor 902 calculates user location and orientation data or, in another embodiment, receives location data from an external transmitter attached to, for example, a building, structure, or landmark/tourist site. FIG. 10 is a flow diagram showing a process of mobile augmented reality; that is, displaying geo-coded data in the content delivery platform where the geo-coded data relates to an object or location. The steps in FIG. 10 are described in conjunction with FIG. 9.

At step 1002, a device, such as an IP-enabled cell phone or other receiving or communication device obtains origin data, which may be location data relating to the location of the user or data sent by a transmitter under control of a specific structure (e.g., a tourist attraction). Location data may be calculated or derived using location sensor 902 on the platform, such as a GPS component, compass, or other known components capable of obtaining location data. Thus, in one embodiment, origin or location data (e.g., latitude and longitudinal coordinates) is transmitted from location sensor 902 to a receiving device 904, such as an IP-enabled cell phone, which may use the data for various functions. In the mobile augmented reality application embodiment, location coordinates (origin data) are used by device 904 to look up specific geo-coded information on the Internet. The format of the location data may vary based on the type of location sensor 902 or location service being used.

At step 1004 a request for specific geo-coded data is transmitted from communication device 904 to the Internet. The request may contain the specific origin or location data obtained from location sensor 902 or from an external transmitter. The location data in the form of a request may then be submitted to any one of numerous sites on the Internet which can provide specific geo-coded information relating to the user's location. For example, a Web site may provide general information such as altitude, population, name of the city or town, the weather, a brief history, and the like. Or it may provide data on a specific attraction or feature at or near the location, such as historical data on a nearby landmark. At step 1006 communication device 904 of the content display platform receives the specific geo-coded data from the Internet. In another embodiment, the data may be obtained from an internal source of device 904 (e.g., an MP3 player or handheld computing device), such as a hard drive or other internal memory, which stores geo-coded data for all or most of the places the user will be visiting and can retrieve it when it receives origin data in step 1002. For example, if the user is near the Eiffel Tower, a transmitter on the tower may transmit location data which is detected by location sensor 902. This data is transmitted to device 904 which obtains historical data.

The historical data (geo-coded data), in the form of text or graphical data is displayed on the display component (e.g., to the side) while the user views the real-world Eiffel Tower in the center where the display component is fully transparent. In another example, where the attraction or site does not have a location data transmitter, location sensor 902 in the platform detect the user's location and transmits to device 904 (e.g., longitude and latitude data, orientation data, etc.). The mobile device transmits this data to one or more Web sites which determine that the user is near the Eiffel Tower. The Web sites retrieve data on the Eiffel Tower and transmit the data back to device 904. Device 904 transmits the data to projector 908 which projects the data on the display component.

Upon receiving location specific information from the Internet, the data is transmitted from device 904 to projector 908 from where it is displayed on the display component as shown in step 1008 of FIG. 10. In this process, the user is able to see geo-coded data, i.e., location-relevant information, on an inner display surface area while looking at a specific attraction or site. In another example, user 906 may be at a street corner in an unknown small town in an area that the user is not familiar with. Location sensor 902 transmits the location or origin data and through the same process (except there is no known attraction or feature of the street corner or the town), user 906 can see data on where she is on the display component, such as the altitude, the county or state the town is in, when the town was founded, the population, and maybe other information on the town, such as restaurants, hotels, etc. while user 906 is viewing the town, specifically the street corner. Presenting this type of data next to a real (actual) view of the location (i.e., while the user is viewing “reality”) is often referred to as “augmented reality.” In the described embodiment, the user is viewing this “augmented reality” while mobile and using the content delivery platform of the various described embodiments.

The mobile multimedia content delivery platform described in the various embodiments may be attached or coupled to a user or be worn by the user as an accessory. In one embodiment, various components of the mobile content delivery platform, in particular the display component, are attached to the user via a backpack-type accessory which allows the user to operate the platform without having to use hands (hands-free implementation). Other components, such as the cameras, projectors, and sensors, may be attached to the display component or other parts of the backpack, which may have a rod protruding from the top that supports the display component. Other embodiments may include the user holding a vertical rod or central axis that supports a display component and the other components (this implementation would not be hands-free). The configuration and placement of projectors, cameras, and other components in the platform will depend in large part on the configuration of the display component. In some configurations, the display component can be used to fix, hold in place, or support other components (such as in the configuration shown in FIGS. 4 to 9) where, for example, components may be fixed to the rim of the display component. In other configurations, support may have to come from a separate mechanical means, such as a rod or a hub-and-spoke type structure (resembling the inner frame of an umbrella), for implementing the components. For example, a vertical rod held by the user may have speakers or projectors attached to it. Other wearable or accessory type mechanisms for making the multimedia platform portable by the user (i.e., mobile) include parasol-type structures, various types of backpack and back-supported apparatus, head gear, including hats, helmets, and the like, umbrellas, including hands-free umbrella devices, and combinations of all the above.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A content delivery system comprising:
a collapsible display component providing an extended field-of-view (FOV) for a user and having an inner display surface;
at least one sensor;
at least one projector for projecting images on the inner display surface; and
an interface for communicating with a processing device.

2. A content delivery system as recited in claim 1 wherein the display component is variably transparent.

3. A content delivery system as recited in claim 1 wherein the display component provides a partial physical enclosure.

4. A content delivery system as recited in claim 1 wherein the display component has a configuration such that when the display component is implemented by the user, there is an opening in the display component above the user.

5. A content delivery system as recited in claim 1 wherein the display has a configuration such that when the display component is implemented by the user, there is an opening in the display component at one side of the user.

6. A content delivery system as recited in claim 1 wherein the display component creates a partially confined space between the user and the inner display surface, thereby facilitating user gesture detection.

7. A content delivery system as recited in claim 1 wherein the display component has a general configuration resembling one of a spherical, tubular, conical, ellipsoidal, and pyramidal shape.

8. A content delivery system as recited in claim 7 wherein the display component has a horizontal cutting plane having a generally horizontal inclination angle.

9. A content delivery system as recited in claim 7 wherein the display component has a vertical cutting plane having a generally vertical inclination angle.

10. A content delivery system as recited in claim 1 wherein the display component is comprised of a self-emitting material.

11. A content delivery system as recited in claim 1 wherein the display component is a combination of polarized light and a polarized projection surface.

12. A content delivery system as recited in claim 1 wherein the system is attached to the user.

13. A content delivery system as recited in claim 1 wherein the system is worn by the user.

14. A content delivery system as recited in claim 1 wherein the system is configured as one of a backpack-type accessory, an umbrella-type accessory, and a head-gear type accessory.

15. A content delivery system as recited in claim 1 wherein the at least one sensor is a camera.

16. A content delivery system as recited in claim 15 wherein the camera is an outward-facing camera facing away from the content delivery system.

17. A content delivery system as recited in claim 15 wherein the camera is an inward-facing camera facing the user.

18. A content delivery system as recited in claim 15 wherein the camera is a depth camera.

19. A content delivery system as recited in claim 1 wherein the at least one sensor is a location sensor.

20. A content delivery system as recited in claim 1 wherein the processing device is a cell phone.

21. A content delivery system as recited in claim 1 wherein the processing device is an MP3 player.

22. A content delivery system as recited in claim 1 wherein the interface communicates data between the processing device and the at least one projector.

23. A content delivery system as recited in claim 1 wherein the interface communicates data between the processing device and the at least one sensor.

24. A content delivery system as recited in claim 1 wherein the system is mobile.

25. A content delivery system as recited in claim 1 wherein the inner display surface functions as a touch screen.

26. A content delivery system as recited in claim 1 wherein the display component is inflatable.

27. A method of mobile group communication, the method comprising:
enabling a phone call between a user and a participant, the user utilizing a mobile phone interfacing with a mobile content display system;
receiving a video stream from the participant via the mobile phone; and
displaying images from the video stream on a display component of the mobile content display system while conducting the phone call, such that the user is able to see the images while being mobile.

28. A method as recited in claim 27 further comprising:
supplying audio to the user via one or more speakers in the mobile content display system.

29. A method as recited in claim 27 further comprising:
receiving multiple video streams.

30. A method as recited in claim 27 further comprising:
transmitting the video stream from the mobile phone to a projector in the mobile content display system.

31. A method as recited in claim 27 wherein displaying images further comprises:
projecting the video stream onto an inner display surface of the display component.

32. A method as recited in claim 27 wherein the display component creates an extended field of view for the user and a partial physical enclosure.

33. A method of displaying in a mobile content display system geo-coded data related to an object or location, the method comprising:
obtaining origin data;
transmitting the origin data to a communication device in the mobile content display system;
transmitting a request for geo-coded data based on the origin data using the communication device;
obtaining the geo-coded data via the communication device; and
displaying the geo-coded data on a display component, such that the geo-coded data augments the object or location.

34. A method as recited in claim 33 wherein obtaining origin data further comprises:
receiving origin data from an external transmitter under control of the object or in the location.

35. A method as recited in claim 33 wherein obtaining origin data further comprises:
utilizing a location sensor in the mobile content display system.

36. A method as recited in claim 33 wherein the communication device is an IP-enabled mobile phone.

37. A content delivery system comprising:
a collapsible display component providing an extended field-of-view (FOV) for a user and having an inner display surface, wherein the display component is a self-emitting material;
at least one sensor; and
an interface for communicating with a processing device.

38. A content delivery system as recited in claim 37 wherein the display component provides a partial physical enclosure.

39. A content delivery system as recited in claim 37 wherein the display component has a general configuration resembling one of a spherical, tubular, conical, ellipsoidal, and pyramidal shape.

40. A content delivery system as recited in claim 37 wherein the at least one sensor is a camera.

41. A content delivery system as recited in claim 37 wherein the camera is a depth camera.

42. A content delivery system as recited in claim 37 wherein the at least one sensor is a location sensor.

43. A content delivery system as recited in claim 37 wherein the interface communicates data between the processing device and the at least one sensor.

44. A content delivery system as recited in claim 37 wherein the system is mobile.

45. A content delivery system as recited in claim 37 wherein the inner display surface functions as a touch screen.
